(19) United States
(12) Patent Application Publication
(10) Pub. No.: US 2009/0033865 A1
(43) Pub. Date: Feb. 5, 2009

(54) CONTACT LENS

(76) Inventor: Han-Yi Chang, Taipei County (TW)

Correspondence Address: BIRCH STEWART KOLASCH & BIRCH, PO BOX 747, FALLS CHURCH, VA, 22040-0747, US

(21) Appl. No.: 11/947,625

(22) Filed: Nov. 29, 2007

(30) Foreign Application Priority Data
Aug. 3, 2007 (TW) 096128547

(51) Int. Cl. G02C 7/04

(52) U.S. Cl. 351/162; 351/160 R

(57) ABSTRACT

A contact lens includes an optical area and a circumferential area. The circumferential area is disposed at the circumference of the optical area. The optical area has a minimum thickness and the circumferential area has a circumferential thickness. The minimum thickness of the optical area is greater than the circumferential thickness.

### CROSS REFERENCE TO RELATED APPLICATIONS

This Non-provisional application claims priority under 35 U.S.C. §119(a) on Patent Application No(s). 096128547 filed in Taiwan, Republic of China on Aug. 3, 2007, the entire contents of which are hereby incorporated by reference.

### BACKGROUND OF THE INVENTION

1. Field of Invention

The invention relates to a lens and, in particular, to a contact lens.

2. Related Art

In comparison with usual glasses, contact lenses do not have the obstacle of a frame and do not change the facial appearance of the user. Therefore, they are welcomed by people who love beauty or sports but need corrections for their eyes.

In recent years, contact lenses are not only used to adjust various visual defects, but farther have different colors and/or become disposable for fashionable users.

FIG. 1 is a cross-sectional view of a conventional contact lens. As shown in FIG. 1, the contact lens 1 includes a first optical area 11 and a second optical area 12. The second optical area 12 is disposed around the circumference of the first optical area 11.

In the prior art, to increase the oxygen transmission rate (OTR) of the contact lens 1, the first optical area 11 and the second optical area 12 are designed to have a thickness of 0.4 mm. However, the edge of such an ultra-thin contact lens 1 may easily break during the manufacturing process, resulting in a low manufacturing yield Therefore, the thickness of the second optical area 12 is often designed to be larger than that of the first optical area 11 in order to increase the manufacturing yield.

The conventional contact lenses 1 have different structures. Please refer to FIG. 2A showing a partially enlarged view of the first optical area 11. The first optical area 11 includes a first optical lens 111, a dye layer 112, and a second optical lens 113. The dye layer 112 is disposed between the first and second optical lenses 111 and 113 to prevent the diffusion of the ionic dyes inside the dye layer 112 that may hurt the user's eyes. However, such a sandwich-like structure involves at least three casting processes. Therefore, the manufacturing yield of the conventional contact lenses 1 is low, and the production cost is higher.

FIG. 2B is an enlarged view of the first optical area 11′ of another contact lens. The first optical area 11′ has an optical lens 111′ and a dye layer 112′. The dye layer 112′ is disposed on the optical lens 111′ by printing or transfer printing. However, the dye layer 112′ is formed on the outer layer of the contact lens, so that the dye in the dye layer 112′ may block pores in the optical lens 111′, resulting in a low OTR. Therefore, it is an important subject to provide a contact lens involving a simple manufacturing process.

### SUMMARY OF THE INVENTION

In view of the foregoing, the invention is to provide a contact lens involving a simple manufacturing process.

To achieve the above, the invention discloses a contact lens including an optical area and a circumferential area. The optical area has a minimum thickness. The circumferential area is disposed around a circumference of the optical area and has a circumferential thickness. The minimum thickness of the optical area is greater than the circumferential thickness of the circumferential area.

As mentioned above, the contact lens of the invention has an optical area and a circumferential area. The minimum thickness of the former is larger than the thickness of the latter. When a user wears the contact lenses of the invention, the optical areas thereof completely cover the user's pupils. When the contact lens is doped with pigments or dyes, the color difference effect due to the different thicknesses of the optical area and the circumferential area renders a larger color difference in the optical area.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a cross-sectional view of the conventional contact lens;

FIG. 2A is a schematic view of the optical area of the conventional contact lens;

FIG. 2B is a schematic view of the optical area of another conventional contact lens;

FIG. 3 is a cross-sectional view of a contact lens according to an embodiment of the invention; and

FIG. 4 is a cross-sectional view of another contact lens according to the embodiment of the invention.

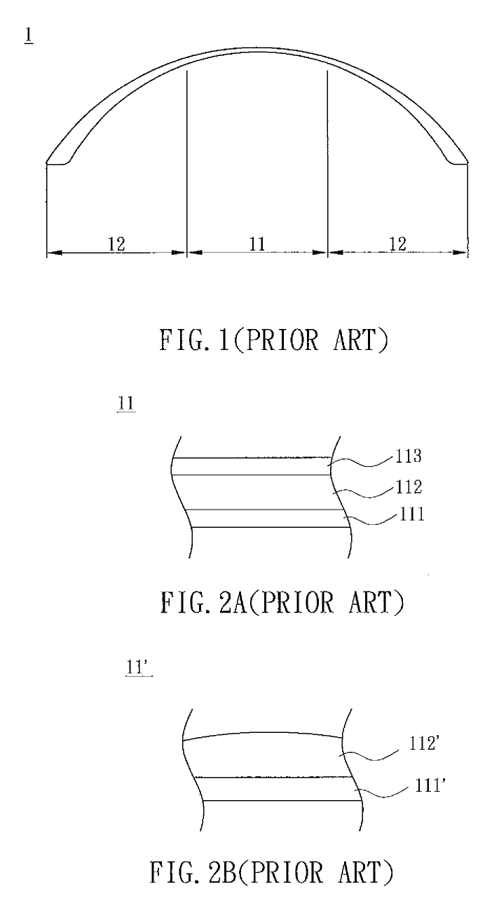

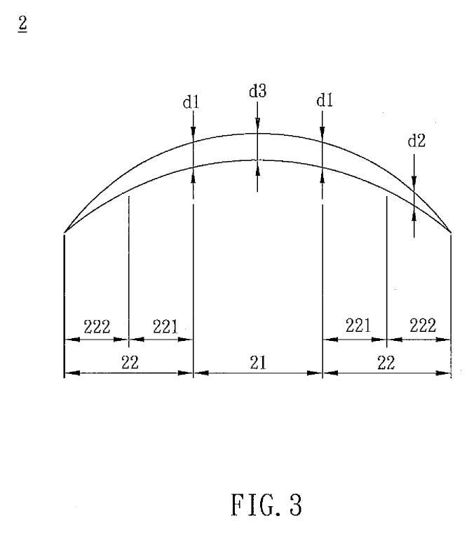

### DETAILED DESCRIPTION OF THE INVENTION

The present invention will be apparent from the following detailed description, which proceeds with reference to the accompanying drawings, wherein the same references relate to the same elements.

With reference to FIG. 3, a contact lens 2 according to a preferred embodiment of the invention includes an optical area 21 and a circumferential area 22. In the embodiment, the contact lens 2 can be produced by pressing molding or ejection molding, so that the optical area 21 and the circumferential area 22 are integrally formed.

The size of the optical area 21 is not restricted by the invention, as long as it can properly cover the pupil of the user.

The circumferential area 22 is disposed around the optical area 21. The optical area 21 has a minimum thickness d1. The circumferential area 22 has a circumferential thickness d2. The minimum thickness d1 of the optical area 21 is larger than the circumferential thickness d2. It should be noted that the position with the minimum thickness d1 does not need to be at the center of the optical area 21. It can be at any position in the optical area 21 instead. As shown in FIG. 3, the position with the minimum thickness d1 is at the border between the optical area 21 and the circumferential area 22. The optical area 21 has a thickest portion at the center and the thickness thereof decreases toward its edge. Preferably, the minimum thickness d1 of the optical area 21 is between 0.06 mm and 2 mm. The circumferential thickness d2 of the circumferential area 22 is between 0.005 mm and 0.06 mm. As shown in FIG. 3, the central thickness d3 of the optical area 21 is greater than twice of the circumferential thickness d2.

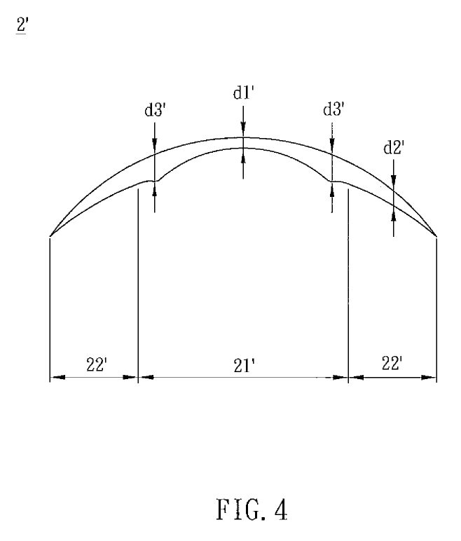

As shown in FIG. 4, to match the shape of user's eyeball, the optical area 21′ of the contact lens 2′ can have several thicknesses. The optical area 21′ has a minimum thickness d1′ and the circumferential area 22′ has a circumferential thickness d2′. Herein, the position with the minimum thickness d1′ is located at the center of the optical area 21′. The thickness of the optical area 21′ increases from the center to its edge.

Referring to FIG. 3 again, the circumferential area 22 has a circumferential light-color area 222 and an arc-optimizing area 221. The arc-optimizing area 221 has several arcs (not shown) connecting with the circumferential light-color area 222 and the optical area 21.

To catch the fashion, the optical area 21 and the circumferential area 22 in this embodiment can be doped with same or different pigments or dyes, so that the contact lens 2 has a color or a pattern. The thickness difference between the optical area 21 and the circumferential area 22 can produce a color difference effect. The color differences in the optical areas 21, 21′ of the contact lenses 2, 2′ are greater than the color differences in the circumferential areas 22, 22′. Therefore, the contact lenses 2, 2′ of the invention can further show the pupil with different colors.

In summary, the contact lens of the invention has an optical area and a circumferential area. The minimum thickness of the former is larger than the thickness of the latter. When a user wears the contact lenses of the invention, the optical areas thereof completely cover the user's pupils. When the contact lens is doped with pigments or dyes, the color difference effect due to the different thicknesses of the optical area and the circumferential area renders a larger color difference in the optical area. In comparison with the prior art, the contact lens of the invention involves a simpler manufacturing process, thereby decreasing the manufacturing cost.

Although the invention has been described with reference to specific embodiments, this description is not meant to be construed in a limiting sense. Various modifications of the disclosed embodiments, as well as alternative embodiments, will be apparent to persons skilled in the al. It is, therefore, contemplated that the appended claims will cover all modifications that fall within the true scope of the invention.

What is claimed is:

1. A contact lens, comprising:
an optical area, which has a minimum thickness; and
a circumferential area, which is disposed around a circumference of the optical area and has a circumferential thickness;
wherein the minimum thickness of the optical area is greater than the circumferential thickness.

2. The contact lens of claim 1, wherein a center thickness of the optical area is greater than or equal to twice of the circumferential thickness.

3. The contact lens of claim 1, wherein the minimum thickness ranges between 0.06 mm and 2 mm.

4. The contact lens of claim 1, wherein the circumferential thickness ranges between 0.005 mm and 0.06 mm.

5. The contact lens of claim 1, wherein the optical area is doped with a pigment or a dye.

6. The contact lens of claim 1, wherein the circumferential area is doped with a pigment or a dye.
